(19) United States
(12) Patent Application Publication
(10) Pub. No.: US 2016/0142791 A1
(43) Pub. Date: May 19, 2016

(54) VIDEO BANDWIDTH ADAPTING DEVICE AND ADAPTING METHOD

(71) Applicant: Aether Services, Taiwan, Ltd., Hsinchu City (TW)

(72) Inventors: Jui-Pin WU, Hsinchu City (TW); Ying-Peng WU, Zhubei City (TW)

(21) Appl. No.: 14/716,431

(22) Filed: May 19, 2015

(30) Foreign Application Priority Data
Nov. 14, 2014 (CN) 201410644163.3

(51) Int. Cl. H04N 21/647; H04N 21/218; H04N 21/6373

(52) U.S. Cl. CPC H04N 21/64769; H04N 21/6373; H04N 21/218

(57) ABSTRACT

Provided is a video bandwidth adapting device and adapting method. This device first sets a plurality of network transmission paths according to bit rate settings of an IP camera (IPCam), selects one from the network transmission paths to acquire a video stream provided by the IPCam, then plays the video stream in a streaming playback manner, and afterwards, when it is determined that an average delay during playing of the video stream reaches or exceeds an upper limit, selects a network transmission path corresponding to a bit rate setting whose level is lower than that of the bit rate setting of the video stream, so as to acquire a video stream with a lower-level bit rate setting through the network transmission path.

### CROSS-REFERENCE TO RELATED APPLICATION

This application claims the benefit of China Patent Application No. 201410644163.3, filed on Nov. 14, 2014, which is hereby incorporated by reference for all purposes as if fully set forth herein.

### BACKGROUND

1. Technical Field

The present invention relates to a video adjustment technology, and in particular, to a video bandwidth adapting device and adapting method.

2. Related Art

In the prior art, an IP camera (IPCam) can be connected to multiple network terminals on the Internet, so that each network terminal can obtain shoot video stream provided by the IPCam. However, since the quality of a network between each network terminal and the IPCam is inconsistent, transmission bandwidth is also different, resulting in that the most appropriate data rate corresponding to each network terminal is different.

If the data rate generated by the IPCam is required to be adjusted according to the network conditions of the network terminals, a processor or a chip with high computational efficacy needs to be configured, which may still make the IPCam bear a large computational burden, and further retard video stream delivery and decrease video stream delivery efficiency. Moreover, not all processors or chips with high computational efficacy are suitable, and only a processor or a chip with sufficient computing power can afford to perform this dynamic computation. Even, designers need to customize the IPCam in functional designs, which also increases the inapplicability of the IPCam.

### SUMMARY

In order to solve the above problems, a main objective of the present invention is to provide a video bandwidth adapting device and adapting method, so as to adjust a video bandwidth according to a delay state during playing of a live video stream.

In order to achieve the above objective, a video bandwidth adapting device disclosed in the present invention is connected to an IPCam, where the IPCam has a plurality of bit rate settings, and the video bandwidth adapting device comprises: a network unit, a detection unit, a computing unit, and a playing unit. Upon being connected to the IPCam by using the network unit, the computing unit establishes a plurality of corresponding network transmission paths according to the bit rate settings, and selects one from the network transmission paths to acquire a video stream provided by the IPCam, so that the playing unit plays the video stream in a streaming manner. The detection unit is connected to the playing unit and detects an average delay during playing of the video stream. When the computing unit determines that the average delay reaches or exceeds an upper limit, the computing unit selects a network transmission path corresponding to a bit rate setting whose level is lower than that of the bit rate setting of the video stream, so as to acquire a video stream with a lower-level bit rate setting.

A video bandwidth adapting method disclosed in the present invention is applicable to a video bandwidth adapting device connected to an IPCam, where the IPCam comprises a plurality of bit rate settings. The method comprises: upon being connected to the IPCam by using a network unit, establishing, by a computing unit, a plurality of corresponding network transmission paths according to the bit rate settings; selecting, by the computing unit, one from the network transmission paths by using the network unit to acquire an video stream provided by the IPCam, and playing the video stream in a playing unit in a streaming playback manner; detecting, by a detection unit, an average delay during playing of the video stream; and when the computing unit determines that the average delay reaches or exceeds an upper limit, selecting a network transmission path corresponding to a bit rate setting whose level is lower than that of the bit rate setting of the video stream, so as to acquire a video stream with a lower-level bit rate setting.

The present invention has the following features. Applicable data rates corresponding to network terminals can be adjusted according to the inconsistent quality of a network between each network terminal and an IPCam. Secondly, it is only required to design the IPCam so that it is applicable to a plurality of bit rate settings, but a processor or a chip with high computational efficacy does not need to be configured for the IPCam; because computation is processed by a video bandwidth adapting device serving as the network terminal, the IPCam is prevented from bearing a large computational burden; and furthermore, a network transmission path is moderately adjusted to acquire a video stream with a lower-level bit rate setting, so as to improve video playing smoothness by playing lower-level bit rate video stream. Thirdly, the IPCam merely needs to maintain standard designs, and does not need to be particularly customized in functional designs, thereby improving the applicability of the IPCam. Fourthly, this is a client side solution, all standard IPCam supporting multiple bit rate video streams can benefit from it.

### BRIEF DESCRIPTION OF THE DRAWINGS

The disclosure will become more fully understood from the detailed description given herein below for illustration only, and thus are not imitative of the disclosure, and wherein:

FIG. 1 is a schematic hardware architecture diagram of a video bandwidth adapting device according to an embodiment of the present invention;

FIG. 2 is a schematic systematic block diagram of a video bandwidth adapting device according to an embodiment of the present invention; and

FIG. 3 is a schematic flow chart of a video bandwidth adapting method according to an embodiment of the present invention.

### DETAILED DESCRIPTION

For further understanding of the objectives, features, structural characteristics and functions of the present invention, the present invention is described in detail below with reference to relevant embodiments and accompanying drawings.

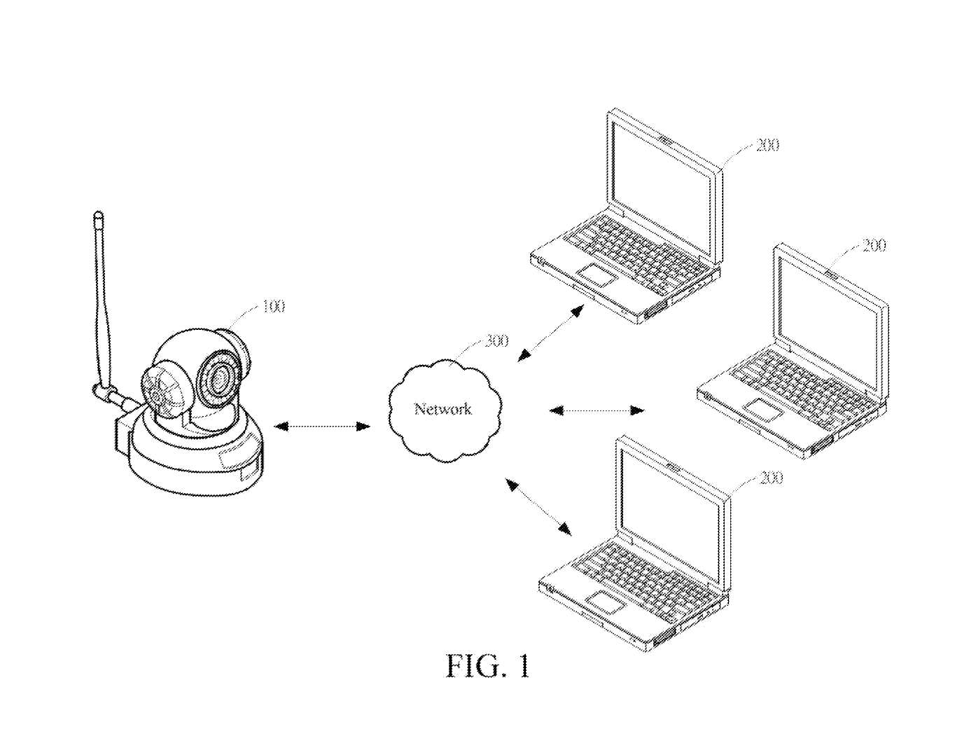

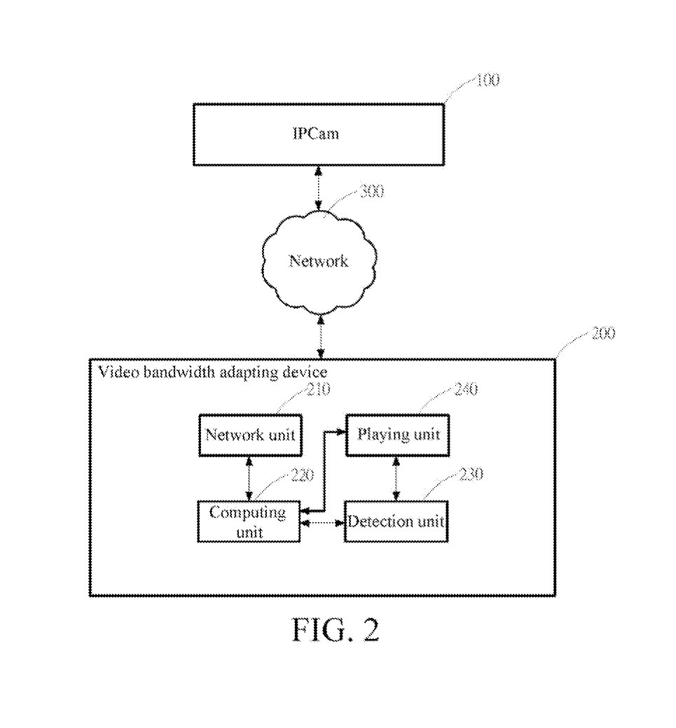

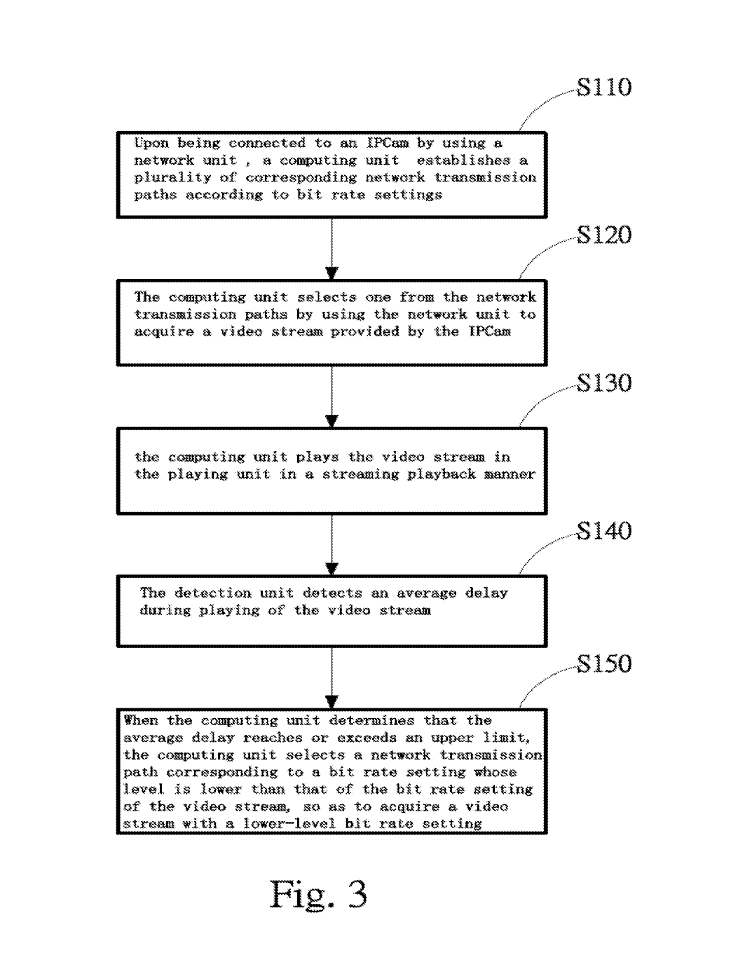

Referring to FIG. 1, FIG. 2 and FIG. 3 together, FIG. 1 is a schematic hardware architecture diagram of a video bandwidth adapting device 200 according to an embodiment of the present invention, FIG. 2 is a schematic systematic block diagram of the video bandwidth adapting device 200 according to an embodiment of the present invention, and FIG. 3 is a schematic flow chart of a video bandwidth adapting method according to an embodiment of the present invention. In FIG. 1, an IPCam 100 may be connected to multiple network terminals through a network 300, where the network terminal may be a personal computer or a portable intelligent electronic device (such as a laptop, a tablet computer, a personal digital assistant, or a smart phone).

The IPCam 100 stores a plurality of bit rate settings. The video bandwidth adapting device 200 includes a network unit 210, a detection unit 230, a computing unit 220, and a playing unit 240. The network unit 210 is used to be connected to the IPCam 100 through a network, and a network connection manner or medium may be wired connection, wireless connection, or collaboration of the wired connection and the wireless connection. The video bandwidth adapting method includes the following steps.

Upon being connected to an IPCam 100 by using a network unit 210, a computing unit 220 establishes a plurality of corresponding network transmission paths according to bit rate settings (Step S110). In this step, upon being connected to the IPCam 100, the computing unit 220 acquires the bit rate settings of the IPCam 100. The computing unit 220 configures a corresponding network transmission path according to each bit rate setting, for example, a network transmission path 1-1080p-4 Mbps, a network transmission path 2-720p-1 Mbps, a network transmission path 3-VGA-256 kbps, a network transmission path 4-QVGA-64 kbps, and the like. Certainly, the bit rate settings and the network transmission path corresponding to each bit rate setting may be preset by means of a man-machine interface of the video bandwidth adapting device 200, and stored in a storage unit or memory of the video bandwidth adapting device 200, while a data construction manner of the network transmission path is not limited.

The computing unit 220 selects one from the network transmission paths by using the network unit 210 to acquire a video stream provided by the IPCam 100 (Step S120). The computing unit 220 is connected to the network unit 210, selects one from all bit rate settings, and is connected to the IPCam 100 through a network transmission path corresponding to the selected bit rate setting, and then receives a video stream through the selected network transmission path. However, the selection of the level of the bit rate setting is determined by the computing unit 220, or determined by the computing unit 220 according to a preset parameter of a program. For example, for the highest level, the computing unit 220 receives, by using the network unit 210, a video stream through a network transmission path corresponding to a bit rate setting of the highest level; and then, the computing unit 220 plays the video stream in the playing unit 240 in a streaming playback manner (Step S130).

The detection unit 230 detects an average delay during playing of the video stream (Step S140). In this step, the detection unit 230 is connected to the playing unit 240 and the computing unit 220. The detection unit 230 detects the average delay during playing of the video stream, and the average delay is a time average of a certain number of captured delays or a time average of all delays in a certain period of time when the playing unit 240 plays the video stream. The type of the delay time also includes a network latency time, which refers to a video stream playing delay caused by insufficient network bandwidth. The detection unit 230 records a video stream playing time. In usually, the video stream playing time is the same as an estimated time calculated by the operating unit 220. When the network bandwidth is insufficient, the speed of the video stream creating is faster than the network transmission. The playing unit 240 cannot play the video stream immediately. The device 200 (operating unit 220) must cache this video stream for some time before playing. Therefore, the playing time runs slower than the actual time. A difference between the actual time during the playing and the estimated time may be used as the network latency time, and is further used as the delay time, but the present invention is not limited thereto, and a stop time, a buffer time and a data read time when the video stream cannot be played actually may also be used as the playing delay time.

When the computing unit 220 determines that the average delay reaches or exceeds an upper limit, the computing unit 220 selects a network transmission path corresponding to a bit rate setting whose level is lower than that of the bit rate setting of the video stream, so as to acquire a video stream with a lower-level bit rate setting (Step S150). In this step, the computing unit 220 determines whether a bit rate setting of the video stream provided by the IPCam 100 reaches the lowest level. The level of the bit rate setting provided by the IPCam 100 is not necessarily the lowest level, so determining needs to be performed first.

When the computing unit 220 determines that the bit rate setting of the video stream provided by the IPCam 100 does not reach the lowest level, the computing unit 220 instructs the IPCam 100 to provide a network transmission path corresponding to a bit rate setting which is lower by at least more than one level, for example, the network transmission path 2-720p-1 Mbps is replaced with the network transmission path 3-VGA-256 kbps. On the contrary, when the computing unit 220 determines that the bit rate setting of the video stream provided by the IPCam 100 has reached the lowest level, the IPCam 100 cannot provide a network transmission path corresponding to a bit rate setting of a lower level. The IPCam 100 can make a decision on its own according to the setting, or the computing unit 220 selects a network transmission path corresponding to a snapshot setting and provided by the IPCam 100, so as to acquire a plurality of snapshots taken by the IPCam 100 by continuously snapshotting. The computing unit 220 continuously plays the snapshots by using the playing unit 240, so as to ensure video stream playing efficacy of a network terminal.

However, the computing unit 220 may pre-store the bit rate settings of the video stream, or the bit rate settings of the video stream may be manually input into the IPCam 100, to provide the bit rate settings, and the computing unit 220 selects according to the average delay a network transmission path corresponding to a bit rate setting matching the average delay. Furthermore, only when the computing unit 220 determines that the average delay reaches or exceeds an upper limit and reaches or exceeds a time limit, the computing unit 220 selects a network transmission path corresponding to a bit rate setting whose level is lower than that of the current bit rate setting of the video stream. The Internet changes all the time, sometimes the network cannot be accessed transitorily, and sometimes the network congests transitorily, which results in that the network latency time is transitorily prolonged. However, once the transitory trouble is eliminated, the network is recovered to be smooth. Therefore, this time limit is provided as an allowable value of the network latency time, so as to allow occurrence of a transitory network trouble.

The invention being thus described, it is not intended to limit the present invention. Any equivalent replacement of modification or improvement made by one skilled in the art without departing from the spirit and scope of the present invention is also intended to be included within the scope of the following claims.

What is claimed is:

1. A video bandwidth adapting device, connected to an IP camera (IPCam), wherein the IPCam comprises a plurality of bit rate settings, and the video bandwidth adapting device comprises:
a network unit;
a detection unit, connected to a playing unit, and used to detect an average delay when the playing unit plays a video stream; and
a computing unit, connected to the network unit, the detection unit and the playing unit, and used to: upon being connected to the IPCam by using the network unit, establish a plurality of corresponding network transmission paths according to the bit rate settings; select one from the network transmission paths to acquire a video stream provided by the IPCam, so that the playing unit plays the video stream in a streaming manner; and upon knowing that the average delay during playing of the video stream and detected by the detection unit reaches or exceeds an upper limit, select a network transmission path corresponding to a bit rate setting whose level is lower than that of the bit rate setting of the video stream, so as to acquire a video stream with a lower-level bit rate setting.

2. The video bandwidth adapting device according to claim 1, wherein when the computing unit determines that the average delay reaches or exceeds an upper limit and the bit rate setting of the video stream provided by the IPCam does not reach the lowest level, the computing unit selects a network transmission path corresponding to a bit rate setting which is lower by at least one level.

3. The video bandwidth adapting device according to claim 1, wherein when the computing unit determines that the average delay reaches or exceeds an upper limit and the bit rate setting of the video stream provided by the IPCam has reached the lowest level, the computing unit selects a network transmission path corresponding to a snapshot setting and provided by the IPCam, so as to acquire a plurality of snapshots taken by the IPCam by continuously snapshotting, and the computing unit plays the snapshots by using the playing unit.

4. The video bandwidth adapting device according to claim 1, wherein the computing unit stores the plurality of bit rate settings of the video stream provided by the IPCam and a network transmission path corresponding to each bit rate setting, and the computing unit selects according to the average delay a network transmission path corresponding to a bit rate setting matching the average delay.

5. The video bandwidth adapting device according to claim 1, wherein when the computing unit determines that the average delay reaches or exceeds an upper limit and reaches or exceeds a time limit, the computing unit selects a network transmission path corresponding to a bit rate setting whose level is lower than that of the bit rate setting of the video stream.

6. A video bandwidth adapting method, applicable to a video bandwidth adapting device connected to an IP camera (IPCam), wherein the IPCam comprises a plurality of bit rate settings, and the method comprises:
upon being connected to the IPCam by using a network unit, establishing, by a computing unit, a plurality of corresponding network transmission paths according to the bit rate settings;
selecting, by the computing unit, one from the network transmission paths by using the network unit to acquire a video stream provided by the IPCam, and playing the video stream in a streaming playing manner in a playing unit;
detecting, by a detection unit, an average delay during playing of the video stream; and
when the computing unit determines that the average delay reaches or exceeds an upper limit, selecting a network transmission path corresponding to a bit rate setting whose level is lower than that of the bit rate setting of the video stream, so as to acquire the video stream with a lower-level bit rate setting.

7. The video bandwidth adapting method according to claim 6, after the step of determining, by the computing unit, that the average delay reaches or exceeds an upper limit, further comprising:
determining, by the computing unit, whether the bit rate setting of the video stream provided by the IPCam reaches the lowest level, and if not, selecting a network transmission path corresponding to a bit rate setting which is lower by at least one level.

8. The video bandwidth adapting method according to claim 6, after the step of determining, by the computing unit, that the average delay reaches or exceeds an upper limit, further comprising:
determining, by the computing unit, whether the bit rate setting of the video stream provided by the IPCam reaches the lowest level, and if yes, selecting a network transmission path corresponding to a snapshot setting and provided by the IPCam, so as to acquire a plurality of snapshots taken by the IPCam by continuously snapshotting.

9. The video bandwidth adapting method according to claim 6, wherein the computing unit stores a plurality of bit rate settings of the video stream provided by the IPCam and a network transmission path corresponding to each bit rate setting, and the computing unit selects according to the average delay a network transmission path corresponding to a bit rate setting matching the average delay.

10. The video bandwidth adapting method according to claim 6, wherein when the computing unit determines that the average delay reaches or exceeds an upper limit and reaches or exceeds a time limit, the computing unit selects a network transmission path corresponding to a bit rate setting whose level is lower than that of the bit rate setting of the video stream.
